(19) United States
(12) Patent Application Publication
(10) Pub. No.: US 2010/0131743 A1
(43) Pub. Date: May 27, 2010

(54) LAZY AND STATELESS EVENTS

(75) Inventors: Henricus Johannes Maria Meijer, Mercer Island, WA (US); John Wesley Dyer, Monroe, WA (US); Jeffrey Van Gogh, Redmond, WA (US); Mark Brian Shields, Seattle, WA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/277,926

(22) Filed: Nov. 25, 2008

(51) Int. Cl. G06F 9/44; G06F 9/00

(52) U.S. Cl. 712/220; 712/E09.003

(57) ABSTRACT

Event-based processing is employed in conjunction with lazy and stateless events. Addition of any handlers is deferred until a user-specified handler is identified. Furthermore, event handlers can be composed at this time including the same properties as underlying events. More specifically, handlers specified on composite events can be composed and propagated up to a one or more related source events. As a result, handlers are not accumulated on composite events thereby making them stateless while allowing equivalent functionality upon invocation of the composed top-level handler.

### CROSS-REFERENCE TO RELATED APPLICATIONS

This application is related to U.S. patent application Ser. No. ______ [Atty. Ref.: MS325084.01/MSFTP2422US, Meijer, et al.], entitled UNIFIED EVENT PROGRAMMING AND QUERIES, filed Nov. 25, 2008, U.S. patent application Ser. No. ______ [Atty. Ref.: MS325083.01/MSFTP2423US, Meijer, et al.], entitled EXCEPTIONAL EVENTS, and U.S. patent application Ser. No. ______ [Atty. Ref: MS325086.01/MSFTP2424US, Dyer, et al.], entitled EXPOSING ASYNCHRONOUS MECHANISMS AS FIRST-CLASS EVENTS, all of even date. The entireties of these applications are incorporated herein by reference.

### BACKGROUND

Event-based systems comprise a plurality of independent program parts or components that communicate by way of notifications. Events generally correspond to notable conditions that cause a change of state such as sensor output, user action, or component message. In other words, an event is a message that indicates that something has happened. Event-based programs and/or portion thereof begin, wait for events, perform some action, and continue until explicitly terminated. By contrast, batch programs begin, perform one or more actions, and stop.

Event-based programs are implemented with two main and tightly coupled components: event triggers (or sources, or senders) and event handlers (or sinks, or receivers). Triggers emit a signal or notification upon detecting the occurrence of an event. One or more event handlers respond to this notification by performing an action specific to the event. For example, upon detection of a button click, an event, some functionality is performed related to the click. Stated differently, a sender can detect an event and transmit a notification to a listening receiver, which can perform some designated action.

In addition to simple events, event-based systems can support more complex processing of composite events. Composite events are events that are derived from or somehow related to one or more other events. For example, combination of two or more events by way of operators such as “and” and “or” result in a composite event. Furthermore, events can be causally related such that the occurrence of a first event causes a second event, for instance. Compositional events are conventionally realized by adding handlers to source and/or composite events that trigger dependent events in a cascading fashion, for instance.

Most all programs, including event-based programs, are subject to errors or abnormal conditions. Such conditions, also called exceptions, (e.g., divide by zero, null pointer reference, out of memory . . . ) correspond to special events that trigger invocation of an exception handler. Exceptions are handled by dedicated systems so as to segment normal from abnormal operation. Conventionally, try-catch blocks are employed around a group of statements that might produce or throw an exception.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to lazy and stateless events. In accordance with one aspect of the disclosure, addition of handlers to event triggers is deferred until a programmer specified handler is identified. Furthermore, event handlers can be composed in conjunction with event compositions. More specifically, handlers can be computed with respect to a specified event as well as events from which the specified event depends. Such computed handlers can then be propagated up to one or more related source events and invoked upon triggering of the source event. Since handlers are not accumulated on composite events, the events are stateless. Furthermore, events can be said to be lazy as handler addition is deferred and composite event handlers are invoked from one or more related source events rather than composite events.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of an event processing system in accordance with an aspect of the disclosed subject matter.

FIG. 2 is a block diagram of a representative handler composition component according to a disclosed aspect.

FIG. 3 is a block diagram of a composite event in accordance with an aspect of the disclosure.

FIG. 4 is a block diagram illustrating event interaction according to an aspect of the disclosure.

FIGS. 5a-b are graphical representations of exemplary code snippets illustrating the difference between conventional and composed event handlers.

FIG. 6 is an exemplary event type diagram in accordance with an aspect of the disclosed subject matter.

FIG. 7 is a block diagram of an event processing system according to a disclosed aspect.

FIG. 8 is an event diagram representing event dependencies of exemplary code in accordance with an aspect of the disclosure.

FIG. 9 illustrates addition of handlers with respect to the event diagram of FIG. 8 in accordance with a disclosed aspect.

FIG. 10 is a flow chart diagram of a method of event processing in accordance with an aspect of the disclosure.

FIG. 11 is a flow chart diagram of a method of event composition in accordance with an aspect of the disclosed subject matter.

FIG. 12 is a flow chart diagram of a method of handler composition according to a disclosed aspect.

FIG. 13 is a block diagram of a system within which aspects of the disclosure can be employed.

FIG. 14 is a schematic block diagram illustrating a suitable operating environment for aspects of the subject disclosure.

FIG. 15 is a schematic block diagram of a sample-computing environment.

### DETAILED DESCRIPTION

Systems and methods pertaining to lazy and stateless events are described in detail hereinafter. Handlers are lazily added to events. More specifically, event handler addition is deferred until a programmer specified handler is added. Composite event handlers can also be composed and propagated to one or more related source events. This further provides laziness, enables equivalent functionality, and stateless composite events.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

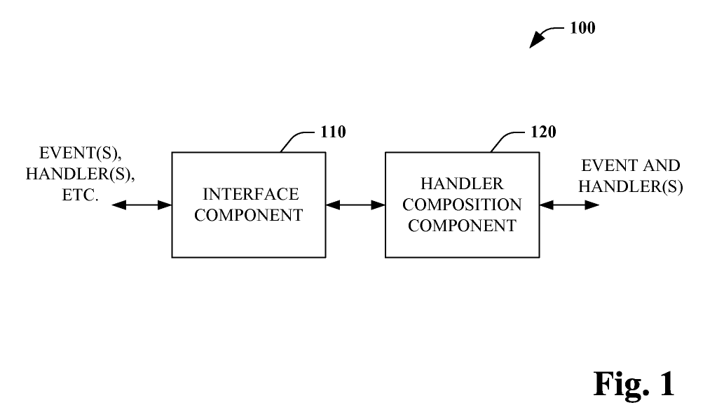

Referring initially to FIG. 1, an event processing system 100 is illustrated in accordance with an aspect of the claimed subject matter. Interface component 110 interacts with an event-based program or system. In particular, the interface component can facilitate provisioning of events, handlers, and other event-based constructs or supporting infrastructure to handler composition component 120, which can perform at least two functions. First, the hander composition component 120 can ensure that handler adding is deferred until a programmer specified handler is identified. In other words, no handlers are automatically generated to support compositional events, as will be described further infra. Second, the handler composition component 120 can compose event handlers and propagate handlers specified with respect to composite or compositional events to related source events. Consequently, composite events need not accumulate event while equivalent functionality is maintained. Events can thus be lazy and stateless.

Conventional event-based systems compose events by creating traditional “trigger+event” style events at each composition. For example in C#, field-like events are declared by marking a field like declaration with the event keyword as follows:

class X
{
public event Action<int> Foo;
}

If another class, say “Y,” then builds a composite event it would typically be done by similarly declaring a new event on “Y” and then hooking up the new event to the underlying event. Consumers of “Y” hook handlers to the new event “Y” as follows:

```
class Y
{
  public event Action<int> Bar;
  X x = new X( );
  public Y( )
  {
      x.Foo += arg => Bar(arg);
    }
}
```

Effectively, class “Y” has become stateful. When an event handler for “Bar” is added, it is accumulated inside “Y.” When the event “Foo” is raised with a value, the handler added by “Y” is invoked. This handler then raises the same value on the event “Bar.” Then, “Bar” invokes its attached handlers.

While straightforward, this approach suffers from several drawbacks. First, a mechanism to raise an event is created for each composition. That is, handlers registered on “Y” are added to the event “Bar.” Second, although “Y” hooks up the firing of “Foo” to fire “Bar,” how does it get unhooked? Lifetime is now not dependent on the handlers that the programmer adds and removes from “Bar,” but rather on the implicit handler added to “Foo” as well as those handlers that the programmer adds. Third, execution is not adequately deferred. As soon as composition occurs, things start to happen. In particular, as soon as a constructor for Y is called, a handler is added to “X's” “Foo” event that will cause “Bar” to be raised. Further, if side effects are specified in combinators, then they begin to occur independently from the addition of handlers.

System 100 resolves these drawbacks among other things. When events are composed, handlers are not implicitly added to related source events, thereby reducing the number of triggers required. Furthermore, handler addition is deferred until a user/programmer actually adds a handler to a composite event, and programmer specified handlers can be added to one or more related source events. Among other things, triggers and handlers are decoupled and enable lazy and stateless events.

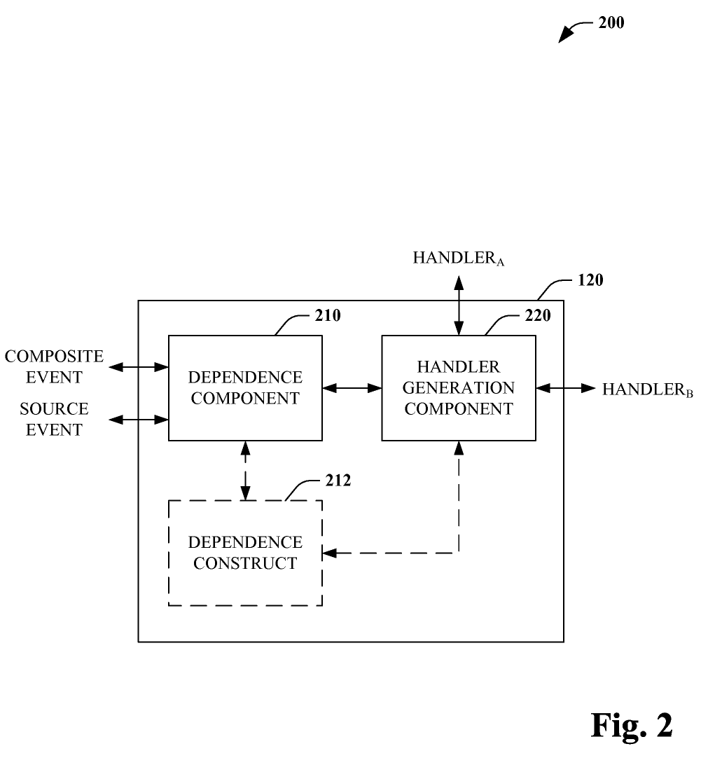

Turning attention to FIG. 2, a representative handler composition component 120 is depicted in accordance with an aspect of the claimed subject matter. The handler composition component 120 includes a dependence component 210 that identified dependency relationships amongst a plurality of events including one or more source and composite events. In accordance with one embodiment, the dependence component 210 can construct a dependence construct 212, such as a dependency graph, to capture such information. The handler generation component can acquire dependency information from the dependence component 210 and/or dependence construct 212 and identification of a specific event handler (HANDLER_{A}) and computes or otherwise produces another handler (HANDLER_{B}).

More specifically, the handler generation component 220 can produce a computed or composed hander that can be added to a source event such that the composite event is stateless and functionality is equivalent. In other words, behavior of a computed or composed handler specified on a source is the same as if the handler is added directly to the composed event. Furthermore, it is to be appreciated that the handler generation component 220 can perform more of an iterative or recursive process where the specified hander is associate with a composed event that itself related to at least one other composite event.

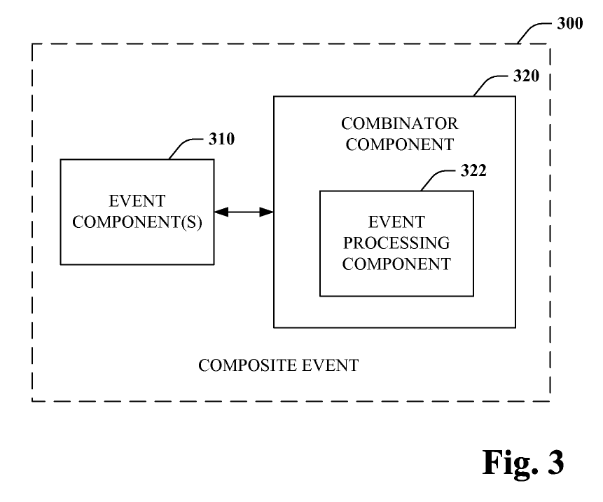

Referring to FIG. 3, a composite event component 300 is illustrated including event component(s) 310 and combinator component 320. A composite or compositional event 300 is an event that that derives from or is somehow related to one or more other events including source events and/or other composite events. Event component 310 corresponds to one or more events or event components that can form the basis of a composite event. The combinator component 320 provides functionality or operations for combining or relating one of more of the event components 310 via predicate or selector functions. For example, the combinator component 320 can provide or be embodied as one or more operators including but not limited to “Select,” “GroupBy,” “Take,” “Join,” “Merge,” and variations thereof Moreover, the combinator component 320 can include event processor component 322 or otherwise include the functionality afforded thereby in accordance with an embodiment of the claimed subject matter. The handler-processing component 322 can implement all or a portion of functionality provided by the system 100 and interface component 110 and/or handler composition component 120. More specifically, the combinator component 320, by way of handler-processing component 322, can implement functionality to make composite events 300 lazy as well as stateless.

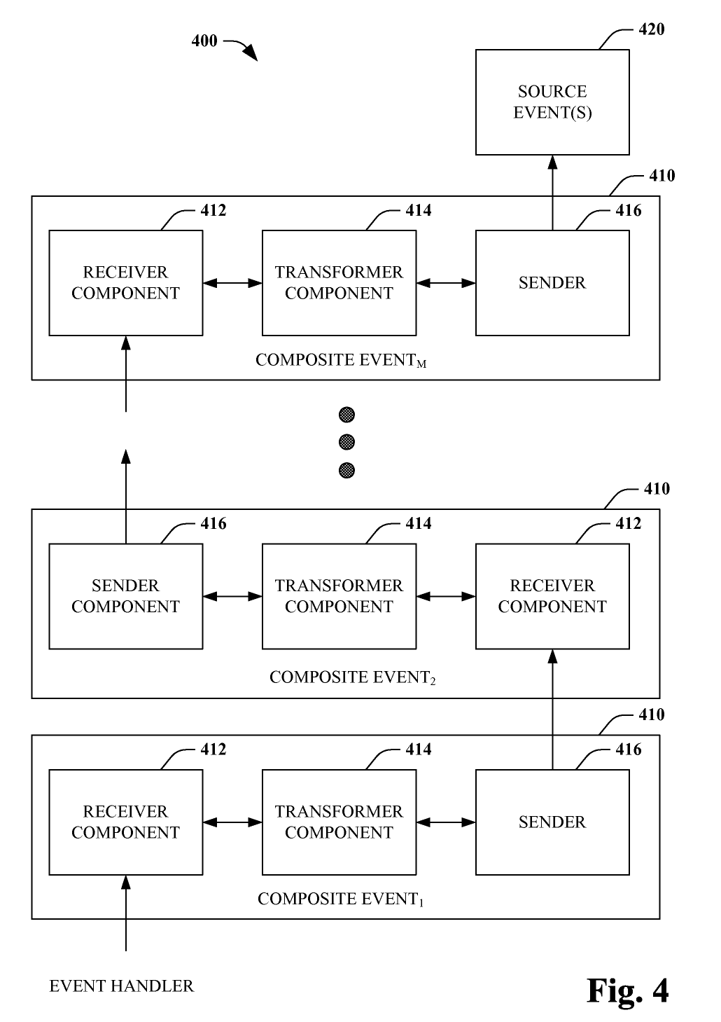

FIG. 4 illustrates a system 400 that captures event interaction in accordance with an aspect of the claimed subject matter. As shown, a plurality of composite event components (COMPOSITE EVENT₁-COMPOSITE EVENT_{M}, where M is an integer greater than or equal to one) 410 can depend from one or more source events 420. Each composite event component 410 can include a receiver component 412, a transformer component 414, and a sender component 416. The receiver component 412 is a mechanism for receiving or otherwise acquiring an event handler or code for adding an event handler. The transformer component 414 transforms an event handler or produces a new handler that captures defining parameters or the like of the associated composite event component 410. The sender component 416 acquires this computed or composed event handler produced by the transformer component 414 and sends it to the next event in a chain of events. The same functionality can be performed by other events until one or more source events 420 are encountered. At this point, the computed or composite hander is added to the source event 420. In other words, rather than holding on to a received handler, each composite event 410 can produce a computed handler that is simply passed to the next event to deal with until a source event 420 is reached. Further, the composite events 410 remain stateless while functionality is preserved at the source event level.

What follows is a description of one particular implementation and associated examples. It is to be appreciated that the claimed subject matter is not meant to be limited by the following specific implement/embodiment. Rather, it is provide to facilitate clarity and understanding with respect to claimed aspects.

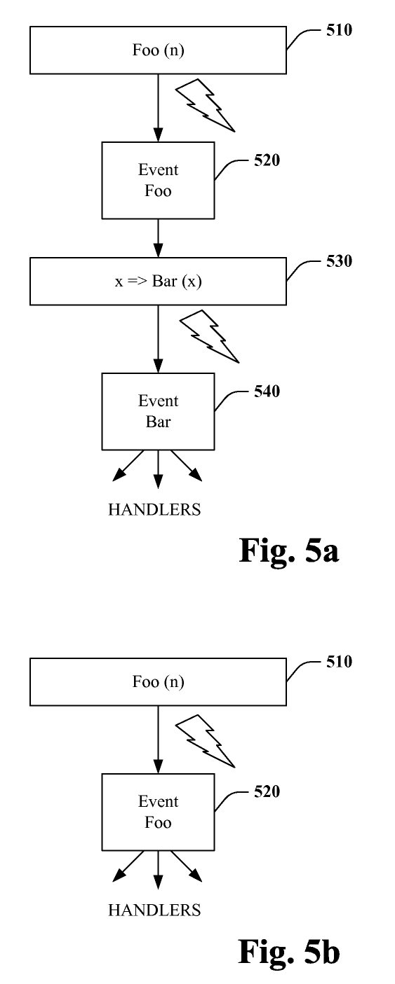

FIGS. 5a and 5b provide a graphical illustration issued addressed by the claimed subject matter. FIG. 5a represents graphically execution of the following previously described code snippet:

```
class X
{
  public event Action<int> Foo;
}
class Y
{
  public event Action<int> Bar;
  X x = new X( );
  public Y( )
  {
      x.Foo += arg => Bar(arg);
    }
}
```

In this conventional approach, a trigger “Foo(n)” 510 is raised to on an event “Foo” 520. Event 520 is associated with a handler 530 (“x=>Bar(x)”) that triggers event “Bar” 540. The event “Bar” can then execute a plurality of associated handlers.

By contract and in accordance with an aspect of the claimed subject matter, a lazy solution is closer to the exemplary code snippet below.

```
class X
{
  public event Action<int> Foo;
}
class Y
{
  X x = new X( );
  public event Action<int> Bar
  {
    add
    {
      x.Foo += value;
    }
  remove
  {
      x.Foo −= value;
    }
  }
}
```

In this case, adding a handler to the “Bar” event in “Y” immediately adds a handler to the underlying event “Foo” in “X.” As a result, “Y” does not accumulate any handlers itself and is purely stateless. It just forwards adding (or removing) the handler to “X.”

The distinction between approaches may be clarified by way of analogy. Consider a line of firefighters that need to move water from a tap to a fire. One possibility is for each firefighter to empty his/her bucket of water into a neighbor's bucket (conventional handler approach). The other is to hand over the whole bucket to the neighbor. In the latter case, the line is stateless; no one keeps a bucket for himself or herself.

Note that the event “Bar” in the above example is not a conventional trigger-event pair. It only includes the ability to add and remove handlers. Furthermore, when a user adds a handler to “Bar,” the handler is actually added to “Foo.” When the event “Foo” is raised, the handlers that were added to “Bar” will be raised directly, as shown in FIG. 5b . Already it is apparent that this form of composition does not suffer from extra trigger nor are any handlers added until a user adds a handler to “Bar.”

In accordance with one aspect of the claimed subject matter, events can be first class program constructs. Conventionally, events are tightly coupled to classes, for example, much like class properties. However, events can be produced that behave as other first class program constructs such as integers. In other words, events can be created and passed around, among other things.

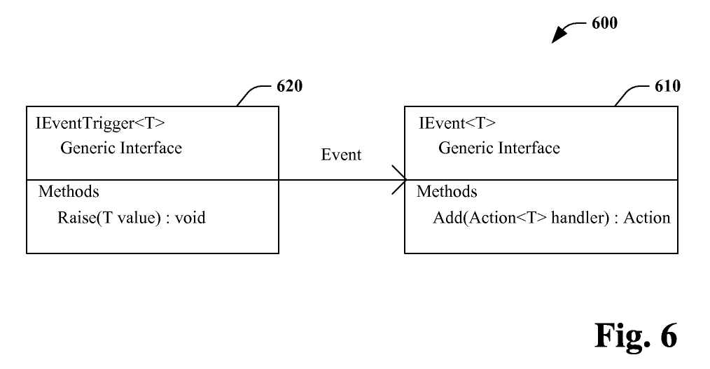

Turning to FIG. 6, a type or interface diagram is provided that models one exemplary event implementation. Here, an event can implement the generic interface “IEvent<T>” 610 with a single method “Add” that enable handlers to be added to an event. As well, the “Add” method returns a function or action execution of which can remove a previously added handler. Furthermore, some events, such as source events, can be associated with triggers that implement the “IEventTrigger<T>” generic interface 620. Here again, a trigger includes only one method, namely “Raise,” which as the name suggests raises a trigger value.

Utilizing first class events, events can be composed utilizing continuation monads. For example, the “Select” combinator can be implemented using closures, such as anonymous inner-classes which implement the laziness as follows:

```
IEvent<U> Select<T, U>(this IEvent<T> e, Func<T, U> f)
{
  return new IEvent<T>( )
    {
    public Action Add(Action<T> handler)
    {
      return e.Add(x =>
      {
            var result = f(x);
            Handler (result);
      });
  };
}
```

Note that no handlers are added to “e” until a handler is added to the result of the “Select” combinatory. Further, where implemented in a language that does not support closures such as anonymous delegates or anonymous inner classes, the anonymous closure design pattern can be implemented explicitly with native constructs or the like.

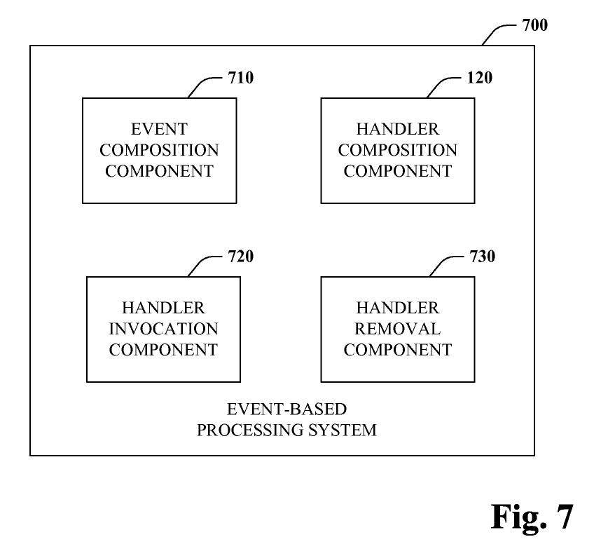

Referring to FIG. 7, an event processing system 700 is illustrated in accordance with one embodiment. As shown, the system 700 can include event composition component 710, handler composition component 120, handler invocation component 720, and hander removal component 730. The event composition component 710 enables event generation and composition. For example, a composite event can be generated that is derived from specified source events. As previously described, the handler composition component 120 is a mechanism that facilitates handler generation and composition. For instance, composite event handlers can computed or composed from one or more dependent composite events and added to one or more source events. The handler invocation component 720 can invoke, raise, or trigger an event, and the handler component 730 can remove a previously added event handler. Table 1 below provides exemplary code associated with each distinct component of the system 700.

TABLE 1

| | |
|---|---|
| Event Composition | var e1 = trigger.Event.Select(x => x + 1); |
| Handler Composition | var r = e1.Add(Console.WriteLine); |
| Handler Invocation | trigger.Raise(1); |
| Hander Removal | r( ); |

It is to be appreciated that in accordance with one aspect of the claimed subject matter, each component accomplishes its purpose in its entirety and only that purpose. Contrast this with conventional trigger-event pair composition where event composition is handler composition (e.g., event composition component 710 and handler composition component 720 collapsed into one).

To facilitate clarity and understanding with respect to event processing or execution consider the following exemplary code:

IEventTrigger<int> trigger1 = new ...;
IEventTrigger<int> trigger2 = new ...;
IEvent<int> e1 = trigger1.Event;
IEvent<int> e2 = trigger2.Event;
IEvent<int> e3 = e1.Where(x => x % 2 == 0);
IEvent<int> e4 = e3.Merge(e2);
IEvent<int> e5 = e4.Select(x => x / 3);

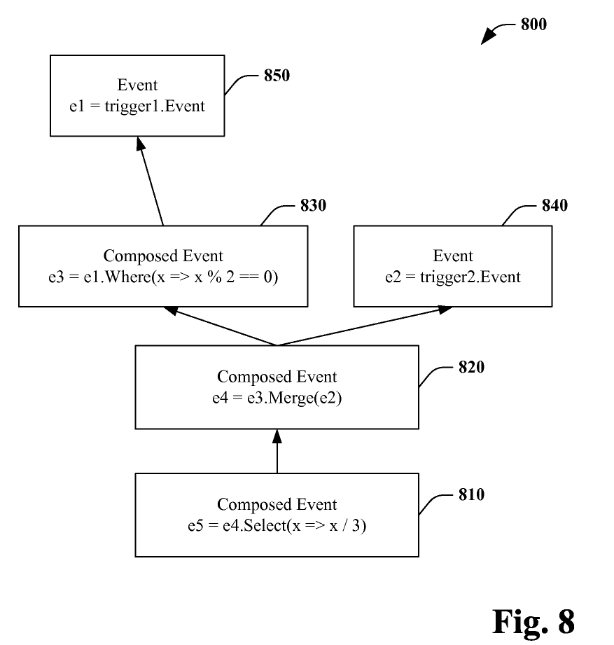

This code illustrates composition of five events “e1,” “e2,” “e3,” “e4,” and “e5,”where “e1” and “e2” are source events while the other are composite events. In accordance with one aspect of the claimed subject matter, a dependency construct can be generated to capture dependencies expressed in the code. FIG. 8 illustrates an exemplary event graph 800 for the above code. As shown, event “e5” 810 depends from event “e4” 820, which depends from compositional event “e3” 830 and source event “e2” 840, while event “e3” 830 also depends from source event “e1” 850.

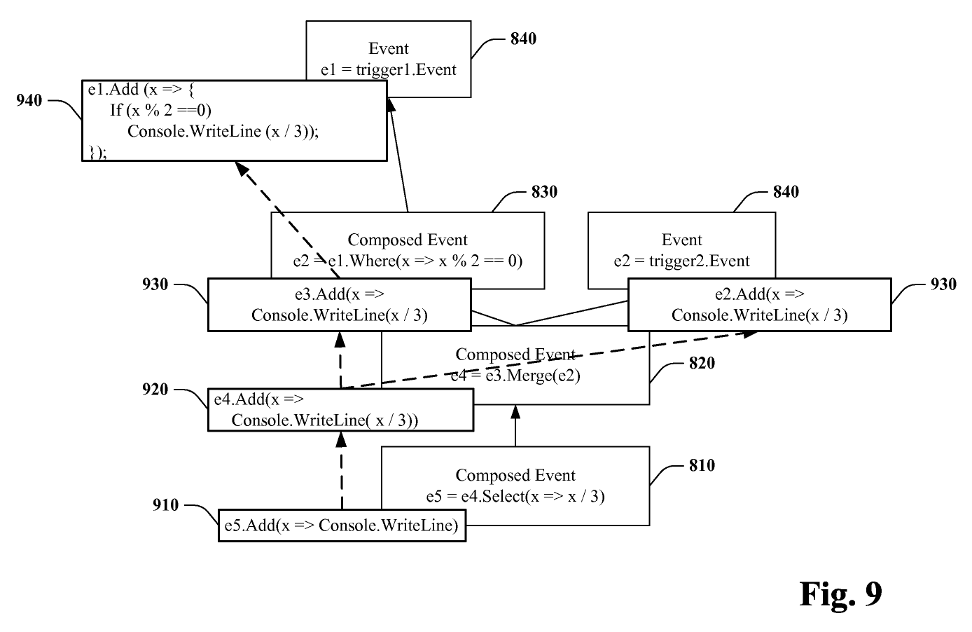

Referring to FIG. 9, handler composition can be initiated when a handler 910 is added to event “e5” 810, for example. This can be represented programmatically as “e5.Add(Console.Writeline),” where the handler renders the event value upon triggering. When the handler 910 is added to “e5” 810, the select combinator's lazy event adds a computed handler 920 to “e4” 820. The merge operator's lazy event then adds the same handler 930 to both “e3” 830 and “e2” 840. Since “e2” 840 is an event-trigger pair or source event, the handler 930 that is added to “e2” 840 is really added to a list of handlers. The handler 930 added to “e3” 830 uses the where combinator's lazy event to add a computed handler 940 to “e1” 850. Note that “e1” is also an event-trigger pair so the handler 940 is added directly to it.

Handler invocation can begin when a trigger raises an event. For example: “trigger1.Raise(1),” which is the same as “if (1% 2=0) Console.WriteLine(1/3).” Recall that when a programmer adds a handler to “e5” 810, handlers were really only added to “e1” 850 and “e2” 840. They were computed based on the lazy events used for the various combinators. Therefore, when an event is raised, the computed handlers are directly invoked and no other triggers need to be raised because of the composition of handlers.

Sometime after a handler is added to an event, handler removal can be initiated where desired. In accordance with one aspect, the “Add” method can return a remove method, but this is not necessary. If a separate remove function is used, then a map should be maintained by each combinatory for each handler, computed handler pair.

According to another aspect, a single event handler can in fact include more than one handler or category of handler. For example, a handler can include values or continuations associated with successful execution and exceptional execution, amongst others. In this scenario, the “Add” method (or associated mechanisms) can be modified to take additional handlers as the exemplary code below illustrates. Composition can still be deferred, but a decision should be made about how the data flows between various categories of handlers:

```
IEvent<U> Select<T, U>(this IEvent<T> e, Func<T, U> f)
{
  return new IEvent<U>( )
    {
    public Action Add(Action<U> handler, Action<Exception>
catchHandler)
    {
      return e.Add(
        x =>
          {
            U result;
            try { result = f(x); }
            catch (Exception ex) { catchHandler(ex); return; }
            handler(result)
          },
        catchHandler);
    }
  };
}
```

The aforementioned systems, mechanisms, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

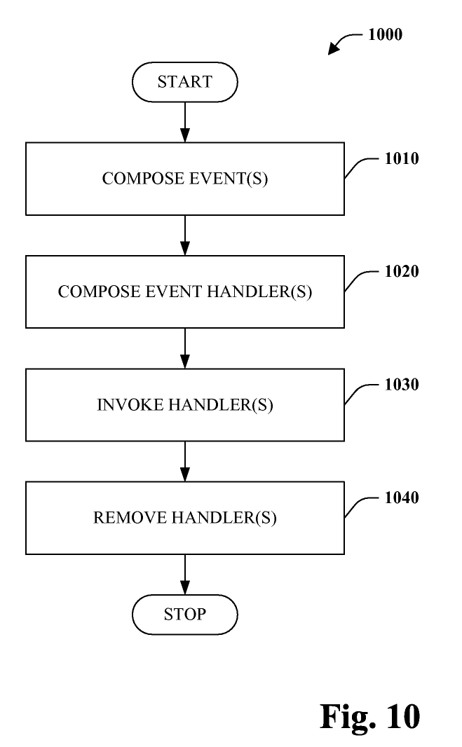

In view of the exemplary systems described supra, methodologies that may be implemented in accordance with the disclosed subject matter will be better appreciated with reference to the flow charts of FIGS. 10-13. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 10, a method of event processing 1000 is illustrated in accordance with an aspect of the claimed subject matter. At reference numeral 1010, events are composed. For example, one or more composite events can be generated from one or more source events. Further, it should be appreciated that at this stage a structure such as an event graph can be created to express dependency relationships amongst events and facilitate subsequent processing. At reference numeral 1020, event handlers are composed. More specifically, event handlers can be computed over specified events, as well as those events from which the specified events depend, and propagated to one or more top-level source events. In other words, addition of handlers to composite events can be pushed to one or more source events in a manner that allows composite events to be stateless while preserving functionality. Furthermore, it is to be noted and appreciated that where single handlers include more than one handler or category of handler (e.g., success, failure . . . ) care should to be taken when composing handlers to ensure correct functionality. Similarly, removal functions also need to be preserved during composition to enable removal of handlers. At numeral 1030, one or more handlers can be invoked. Since handlers are composed, handler invocation can be focused on top-level source events. Therefore, there is no need for triggers and invocation with respect to specific composite events. At reference 1040, one or more of previously added handlers can be removed.

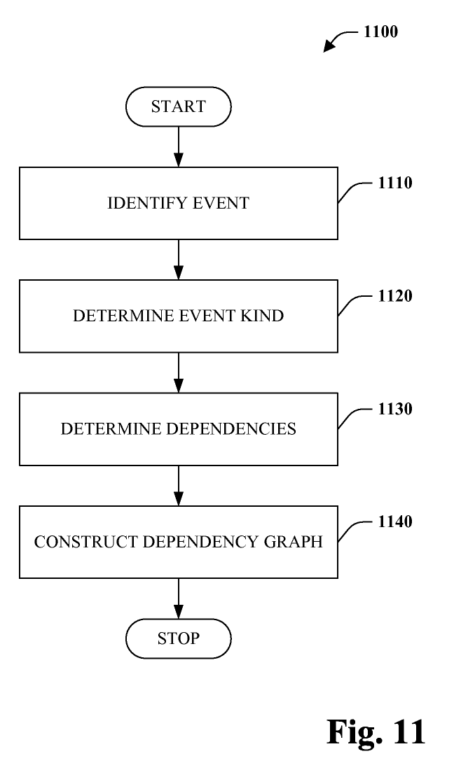

FIG. 11 is a flow chart diagram of a method of event composition 1100 in accordance with an aspect of the claimed subject matter. At reference numeral 1110, each event of a given system is identified. At numeral 1120, the category or kind of each identified event is determined (e.g., source event or composite event). Dependencies amongst all identified source and composite events are determined at reference 1130, and a structure such as a dependency graph is generated and numeral 1130 to capture dependent relationships between and amongst events. Among other things, the generated structure can facilitate composition of event handlers.

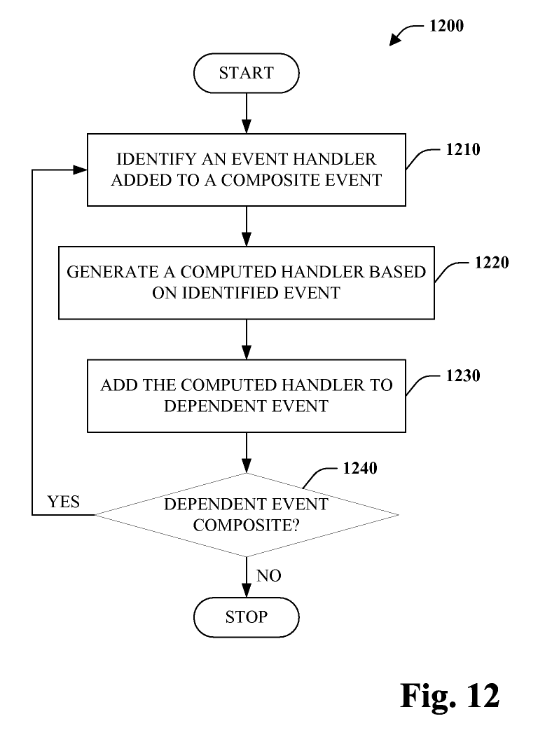

FIG. 12 depicts a method of event handler composition 1200 in accordance with an aspect of the claimed subject matter. At reference numeral 1210, an event handler to be added to a composite event is identified. A computed handler is generated as a function of an event on which the handler is specified and/or functionality associated with the event, at reference 1220. At numeral 1230, the computed handler is added or otherwise passed to an event from which the current event depends. For example, method that adds a handler can be generated or otherwise transformed to include an event specific handler that is passed upward in a chain of events. At reference numeral 1240, a determination is made as to whether or not the event from which the current events depends is also a composite event. If yes, the method proceeds back to numeral 1210 so that yet another computed event handler can be generated and passed. If no, the method simple terminates as the handler can now be added to a source event.

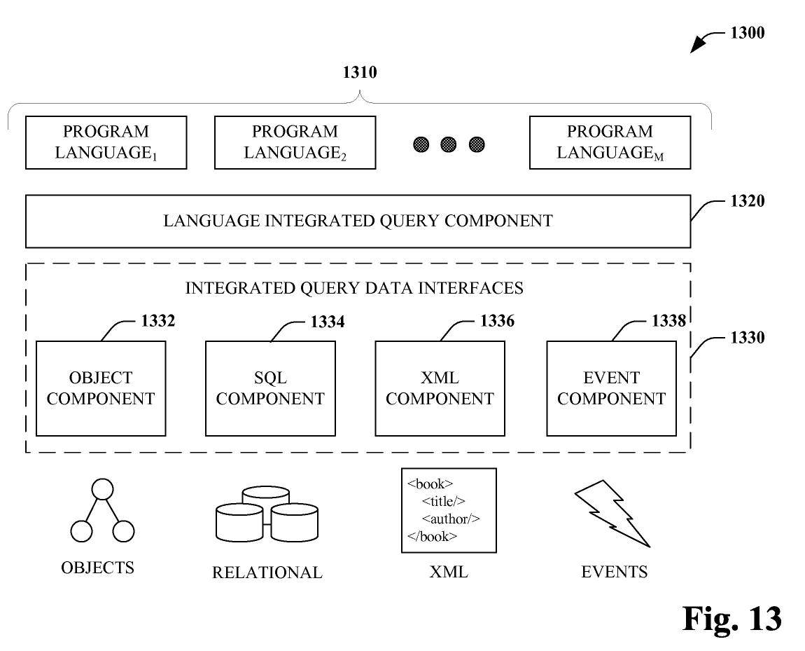

Turning attention to FIG. 13, an exemplary system 1300 is provided for which aspects of the claimed subject matter can be employed. In particular, the system 1300 can operate over a plurality of programming languages 1310 (PROGRAM LANGAUGE₁-PROGRAM LANGUAGE_{M}, where M is an integer greater than or equal to one). For example, such languages can include but are not limited to C#, Visual Basic, and Java. Further, the system 1300 includes a language integrated query component, facility or the like 1320. This component 1320 enables integration of declarative style queries, similar to those utilized with respect to SQL (Structured Query Language), to be integrated with a user's primary programming language 13 10. Further, the component 1320 allows query expressions to benefit from compile-time syntax checking, static typing, and intelligent assistance, among other things previously only available to imperative code. Additionally, the system 1300 includes a plurality of integrated query data interfaces 1330. These interfaces 1330 allow queries over different types of data. As shown, object component 1332 enables queries over objects; SQL component 1334 allows structured query language queries over relational data; and XML component 1336 enables interaction with extensible markup language (XML) data. Moreover, event component 1338 enables language-integrated queries over events. It is here where aspects of the claimed subject matter can be incorporated.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

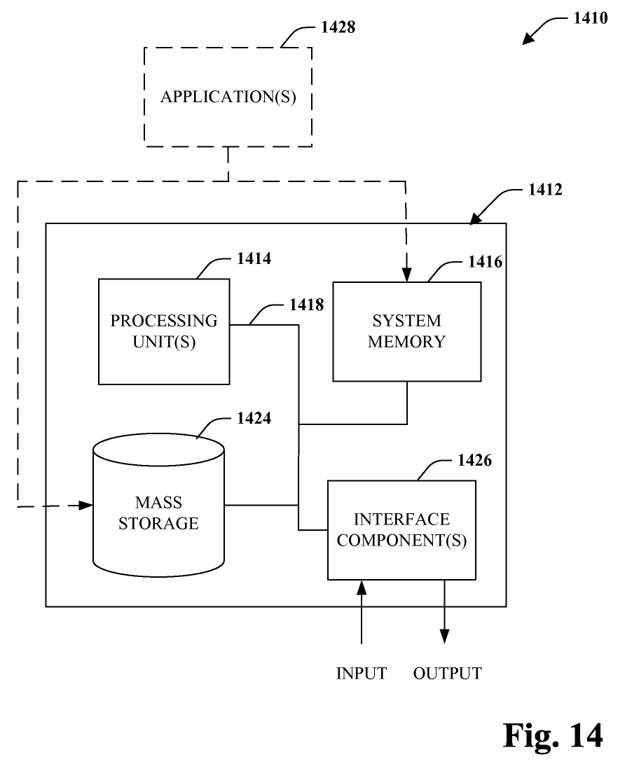

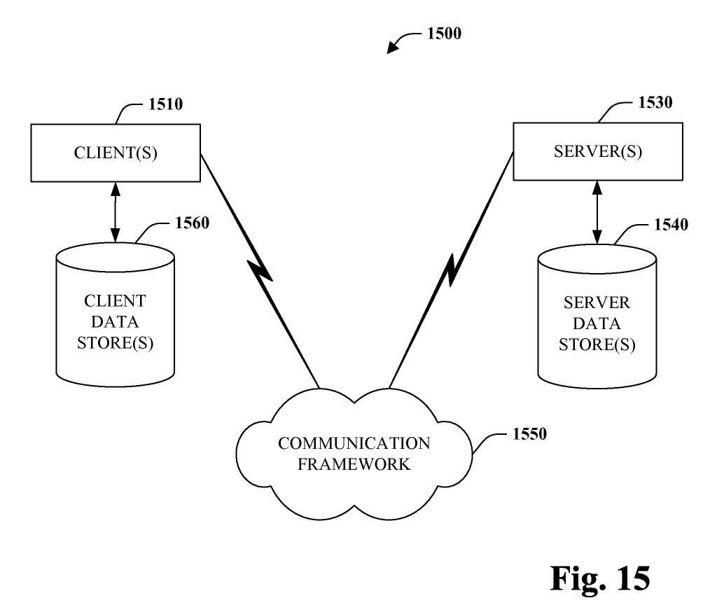

In order to provide a context for the various aspects of the disclosed subject matter, FIGS. 14 and 15 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 14, an exemplary environment 1410 for implementing various aspects disclosed herein includes a computer 1412 (e.g., desktop, laptop, server, hand held, programmable consumer or industrial electronics . . . ). The computer 1412 includes a processing unit 1414, a system memory 1416, and a system bus 1418. The system bus 1418 couples system components including, but not limited to, the system memory 1416 to the processing unit 1414. The processing unit 1414 can be any of various available microprocessors. It is to be appreciated that dual microprocessors, multi-core and other multiprocessor architectures can be employed as the processing unit 1414.

The system memory 1416 includes volatile and nonvolatile memory. The basic input/output system (BIOS), containing the basic routines to transfer information between elements within the computer 1412, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1412 also includes removable/non-removable, volatile/non-volatile computer storage media. FIG. 14 illustrates, for example, mass storage 1424. Mass storage 1424 includes, but is not limited to, devices like a magnetic or optical disk drive, floppy disk drive, flash memory, or memory stick. In addition, mass storage 1424 can include storage media separately or in combination with other storage media.

FIG. 14 provides software application(s) 1428 that act as an intermediary between users and/or other computers and the basic computer resources described in suitable operating environment 1410. Such software application(s) 1428 include one or both of system and application software. System software can include an operating system, which can be stored on mass storage 1424, that acts to control and allocate resources of the computer system 1412. Application software takes advantage of the management of resources by system software through program modules and data stored on either or both of system memory 1416 and mass storage 1424.

The computer 1412 also includes one or more interface components 1426 that are communicatively coupled to the bus 1418 and facilitate interaction with the computer 1412. By way of example, the interface component 1426 can be a port (e.g., serial, parallel, PCMCIA, USB, FireWire . . . ) or an interface card (e.g., sound, video, network . . . ) or the like. The interface component 1426 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer, and the like. Output can also be supplied by the computer 1412 to output device(s) via interface component 1426. Output devices can include displays (e.g., CRT, LCD, plasma . . . ), speakers, printers, and other computers, among other things.

FIG. 15 is a schematic block diagram of a sample-computing environment 1500 with which the subject innovation can interact. The system 1500 includes one or more client(s) 1510. The client(s) 1510 can be hardware and/or software (e.g., threads, processes, computing devices). The system 1500 also includes one or more server(s) 1530. Thus, system 1500 can correspond to a two-tier client server model or a multi-tier model (e.g., client, middle tier server, data server), amongst other models. The server(s) 1530 can also be hardware and/or software (e.g., threads, processes, computing devices). The servers 1530 can house threads to perform transformations by employing the aspects of the subject innovation, for example. One possible communication between a client 1510 and a server 1530 may be in the form of a data packet transmitted between two or more computer processes.

The system 1500 includes a communication framework 1550 that can be employed to facilitate communications between the client(s) 1510 and the server(s) 1530. The client(s) 1510 are operatively connected to one or more client data store(s) 1560 that can be employed to store information local to the client(s) 1510. Similarly, the server(s) 1530 are operatively connected to one or more server data store(s) 1540 that can be employed to store information local to the servers 1530.

Client/server interactions can be utilized with respect with respect to various aspects of the claimed subject matter. By way of example and not limitation, one or more of the aforementioned components and/or actions can be embodied as a network or web service. Additionally or alternatively, a program include lazy and/or stateless events can be split for execution across a client 1510 and a server 1530, wherein communications are performed over the communication framework 1550.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. An event-based processing system, comprising:
an interface component that identifies event-based constructs including first class events; and
a handler composition component that defers addition of any event handlers until a user-specified handler is identified upon which the handler is lazily added to an event.

2. The system of claim 1, further comprising a dependency component that determines dependency relationships between source and composite events.

3. The system of claim 2, further comprising a handler generation component that generates a computed handler for addition to a related source event as a function of a specified event and one or more events from which the specified event depends.

4. The system of claim 3, functionality of the handler composition and generation components is captured by a combinator component that produces a composite event as a function of one or more source and/or composite events and predicates or selector functions.

5. The system of claim 4, the combinator component employs closures with deferred event handler additions.

6. The system of claim 4, the combinator component employs an explicit closure class design pattern with deferred event handler additions.

7. The system of claim 3, the handler generation component maintains multiple handler categories including at least success and failure values or continuations.

8. The system of claim 3, the handler composition component maintains removal functions associated with the handler that enables an added handler to be removed.

9. A method of event execution, comprising:
composing first class events; and
lazily adding handlers to source events as a function of event dependencies.

10. The method of claim 9, further comprising generating a computed handler for handlers specified on composite events and propagating the computed hander to one or more related source events such that the composite events are stateless.

11. The method of claim 10, comprising propagating the handlers lazily by way of one or more combinators that define composite events.

12. The method of claim 11, employing closures or an explicit closure design pattern to enable lazy adding.

13. The method of claim 10, further comprising invoking the computed handler for a composite event when the event is raised.

14. The method of claim 10, further comprising maintaining a removal function associated with the computed handler to facilitate removal of the handler.

15. The method of claim 14, further comprising executing the removal function to remove a handler.

16. The method of claim 10, further comprising maintaining multiple handler categories corresponding to at least success and failure for the computed handler.

17. The method of claim 9, comprising implementing the first class events using continuation monads.

18. An event processing method, comprising:
constructing a composite event; and
deferring addition of any event handlers until a handler is specified by a user.

19. The method of claim 18, further comprising:
acquiring a handler for the composite event,
computing a handler as a function of the acquired handler; and
adding the computed handler to a source event related to the composite event.

20. The method of claim 19, further comprising invoking the computed hander when an event is raised.
